(19) United States
(12) Patent Application Publication
(10) Pub. No.: US 2022/0109289 A1
(43) Pub. Date: Apr. 7, 2022

(54) Electrical wiring outer coating splitting device

(71) Applicants: Jeffrey J. Michaud, Westminster, VT (US); Patrick W. Boylan, Bellows Falls, VT (US)

(72) Inventors: Jeffrey J. Michaud, Westminster, VT (US); Patrick W. Boylan, Bellows Falls, VT (US)

(21) Appl. No.: 16/974,106

(22) Filed: Oct. 1, 2020

(51) Int. Cl. H02G 1/12; A41H 31/00; B25B 23/16; B25G 1/08

(52) U.S. Cl. CPC H02G 1/1234; B25G 1/085; B25B 23/16; A41H 31/005

(57) ABSTRACT

An electrical wire outer coating splitting device featuring an elongated sleeving element, a nearly as long closed hole space within the sleeving element and having a vertically inclined central axis of symmetry and with the notch portion thereof cut into the outer walling of the sleeving element at a bias relative to the lie of the axis of symmetry and with the notch portion thereof being further amenable to removable receipt and dependable holding of the body portion of a seam ripper element.

### PRIOR OR PARENT PATENT APPLICATIONS

The present invention is the subject of a parent patent application being that application with Ser. No. 15/999,992 currently under examination with Mr. Robert J. Scruggs within Art Unit #: 3723.

### FEDERALLY SPONSORED RESEARCH AND DEVELOPMENT

The present invention is not the subject of any federally sponsored research and/or development.

### BACKGROUND OF THE INVENTION

### a. Field of Invention

The present invention is one of those devices that serve to facilitate the splitting and abrogation of portions of the outer coating material about electrical wiring.

### A SUMMARY OF THE INVENTION

### a. A Brief Description of the Invention

The invention features a sleeving element within which there is found a closed hole space. The sleeving element is, for e.g., the first embodiment of the invention, an element fittable, via its within closed hole space, over and about one handle member of a garden variety electrical wire cutting device. Found within a portion of the exterior walling of the sleeving element of the invention is a thinly cut notch. The notch is roughly right triangular in shape. The sleeving element of the second embodiment is shaped as a screwdriver head within which there is a closed hole space for receipt of the shaft portion of the screwdriver. Found within a portion of the exterior walling thereof is a thinly cut notch. Finally, the invention features a seam ripper element being either a seamstress' seam ripper unit or the equivalent of the same that is removably receivable and held within the notch as found within the exterior walling of each embodiment.

### b. Object of the Invention

At present, an electrical knife unit, resembling somewhat a box cutter knife unit is typically used by electricians to initially split the outer coating material circumscribing electrical wiring for ultimate installation of such wiring within a building in, e.g., an electrical switching unit. Such outer coating material snugly circumscribes a ground wire encased within protective sheathing, and each of an unsheathed neutral wire and a so-called “live” wire which is also encased within protective sheathing. A problem however typically encountered by such electricians when so splitting such outer coating material is that, invariably, in the process of doing so, they cause multiple nickings within such protective sheathing. Such nickings can serve to promote accordant sites of electrical arcing and/or manifest overheating post-installation within the environs of such a switching unit, once a system made up of such wiring is ultimately powered up. Such arcing or short circuiting is an obvious fire hazard for the building containing such an installation. Post installation and prior to powering up, very often, inspectors are called upon to visualize the integrity of such sheathing and especially the sheathing about the “live” wire within the vicinity of any such switching unit. Once any such nicking is observed by such an inspector, an order will invariably be issued by the inspector requiring that all of the wiring within and also leading up to the vicinity of the switching unit be promptly removed and replaced. Such orders are issued, not only for safety reasons but also, because any installation of any such wiring with any such nicking is invariably violative of State and local electrical codes. This removal and replacement can prove to be very expensive in terms of labor and materials to all parties concerned with the matter of such installation.

The invention, with resort to the seam ripper element thereof for purposes of so splitting such outer coating material, serves to wholly and completely obviate any possibility of any such nicking of any such sheathing material. In view of the fact of the same, the invention is not only new and unique but is also unquestionably useful.

### A BRIEF DESCRIPTION OF THE DRAWINGS

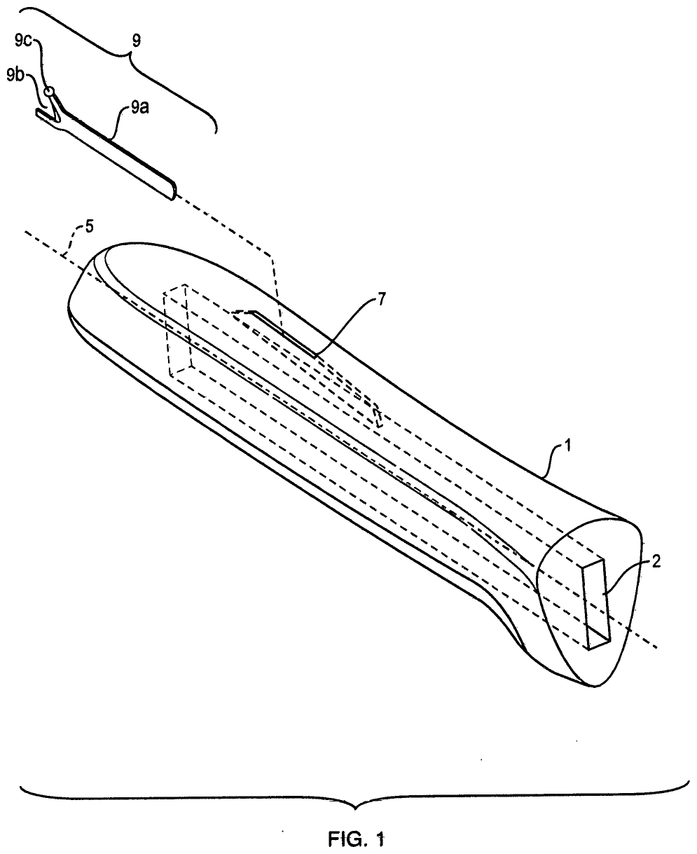

1. FIG. 1 shows in an exploded perspective view, the elongated sleeving element of the first embodiment of the invention in apposition to the seam ripper element of the invention.

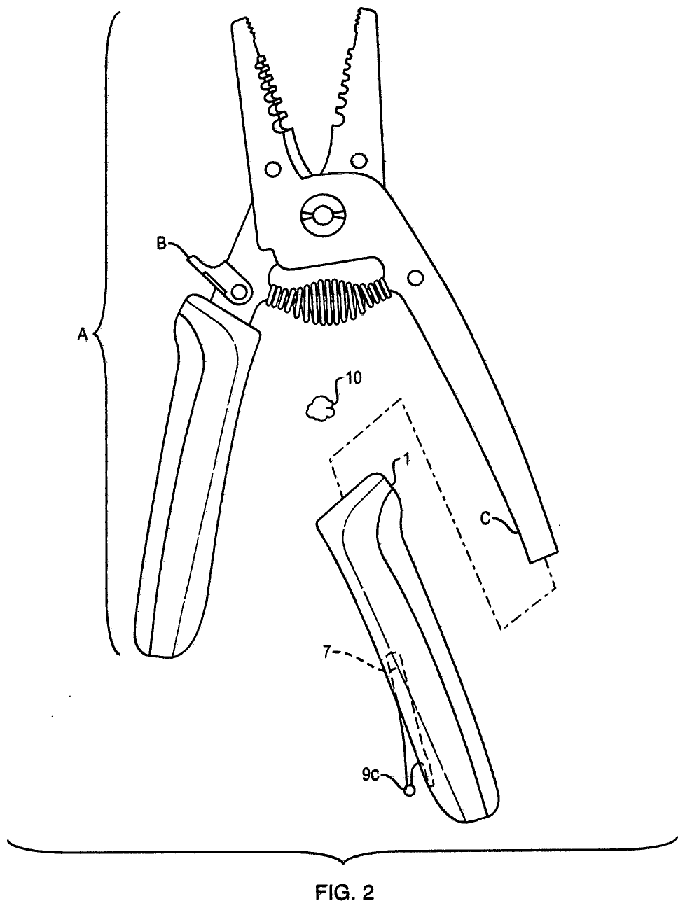

2. FIG. 2 shows the elements of the first embodiment of the intact invention in near apposition to one handle member portion of an unlocked electrical wire cutting device.

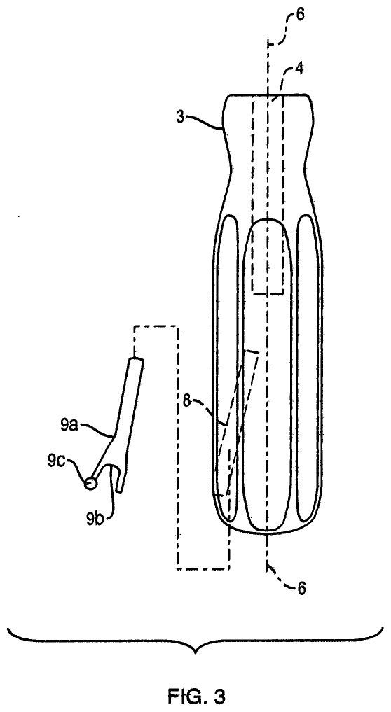

3. FIG. 3 shows in an exploded perspective view, the elongated sleeving element of the second embodiment of the invention in apposition to the seam ripper element of the invention.

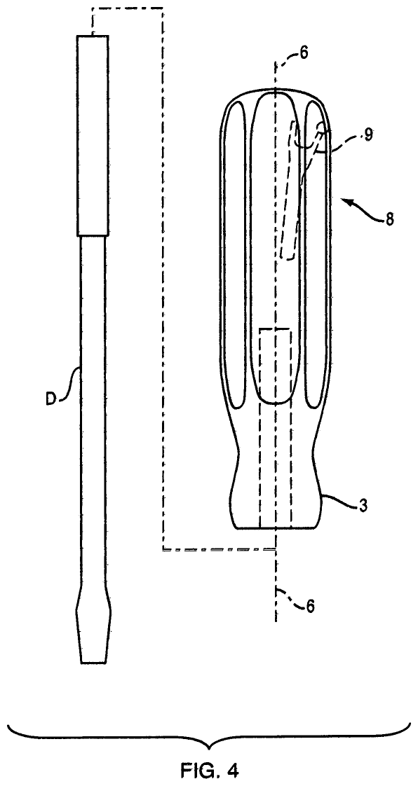

4. FIG. 4 shows the elements of the second embodiment of the instant invention in apposition to the shaft member portion of a conventional screwdriver.

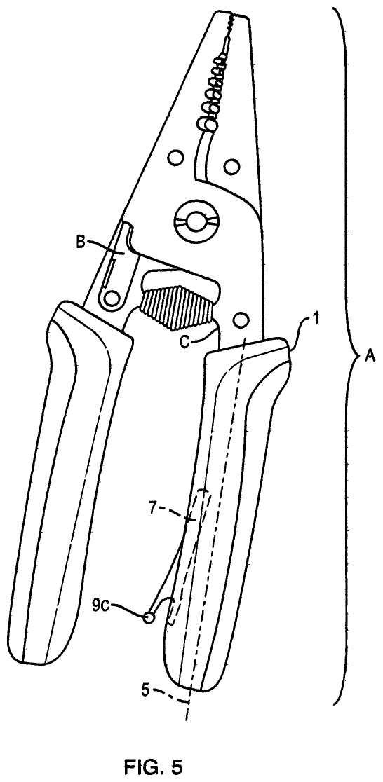

5. FIG. 5 shows the first embodiment of the invention fully assembled to a locked electrical wire cutting device.

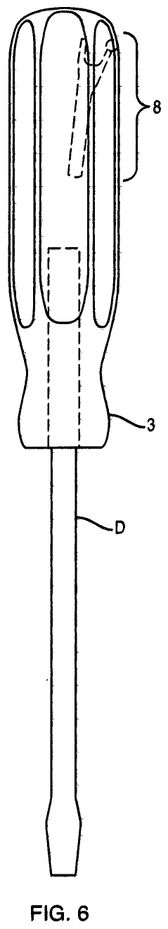

6. FIG. 6 shows the second embodiment of the invention fully assembled to the shaft member portion of a conventional screwdriver.

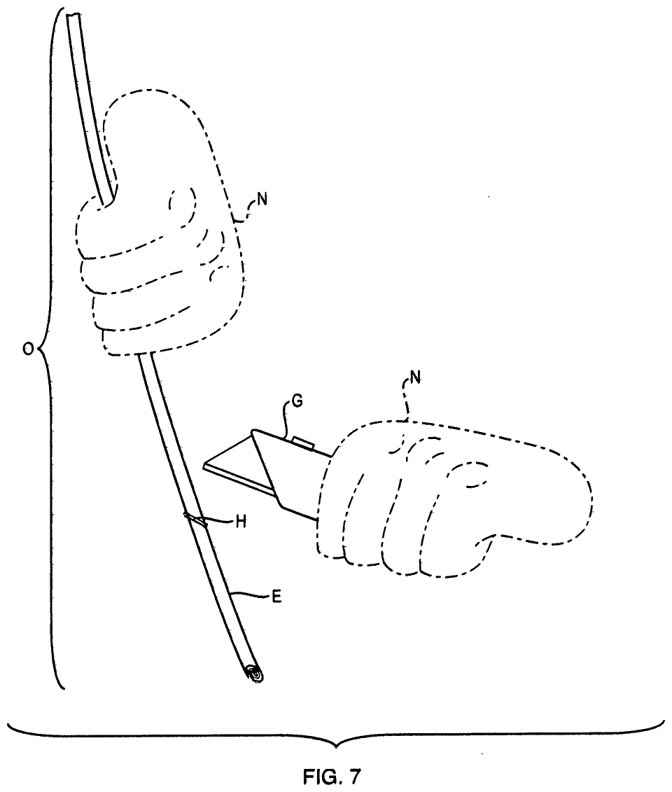

7. FIG. 7 shows the initial splitting of the outer coating of an electrical wiring complex being undertaken with resort to use of an electrical wire cutting knife.

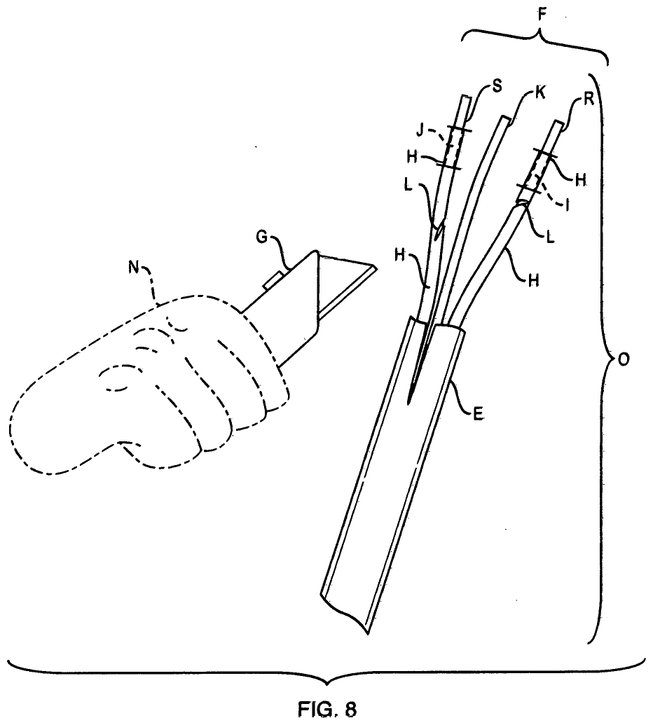

8. FIG. 8 shows the nickings within the wiring's protective sheathing following such splitting as so shown in FIG. 7.

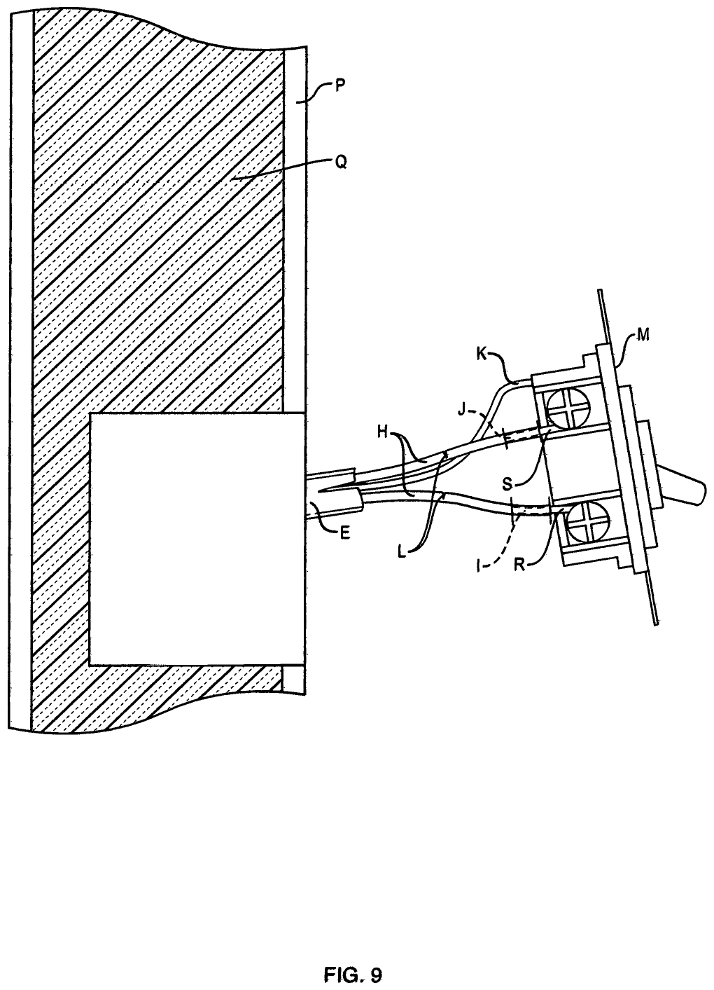

9. FIG. 9 shows wiring with such nickings installed within a switching unit found within the walling of a room within a building.

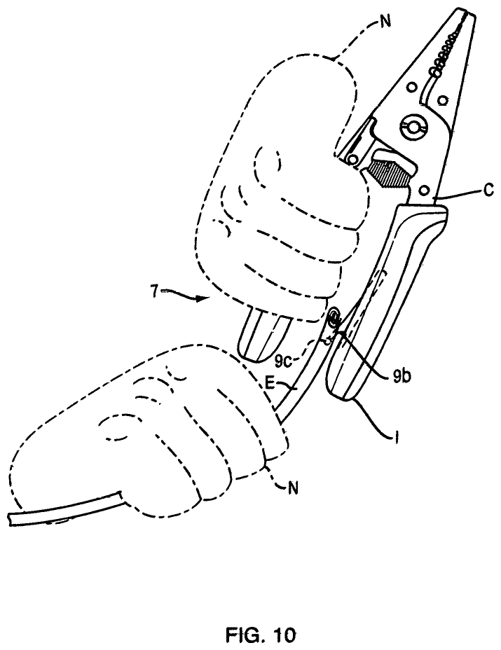

10. FIG. 10 shows such initial splitting with resort to use of the first embodiment of the invention.

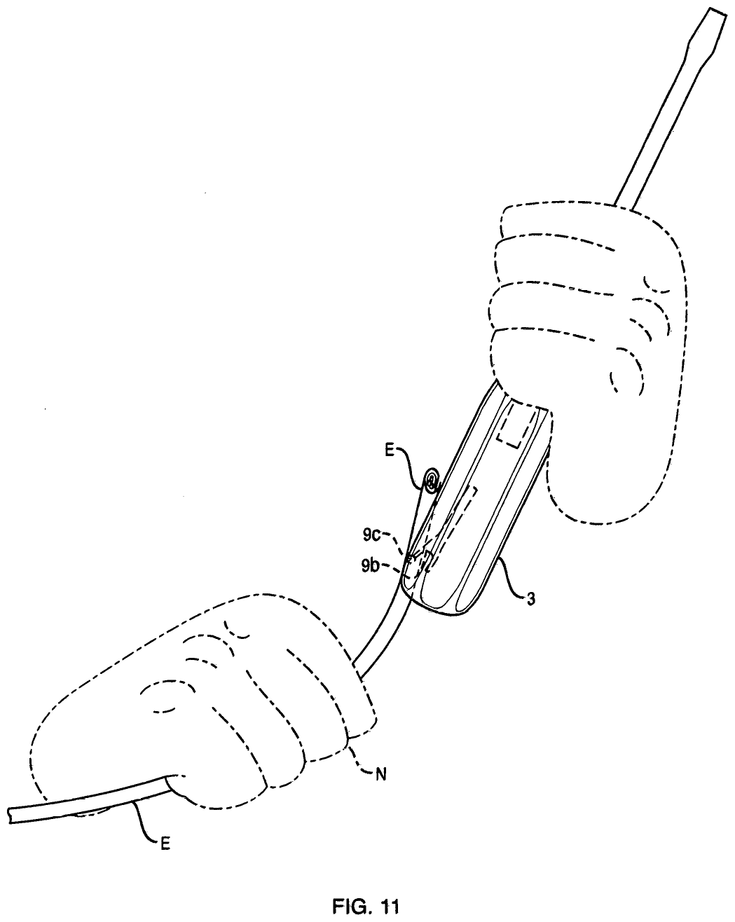

11. FIG. 11 shows such initial splitting with resort to use of the second embodiment of the invention.

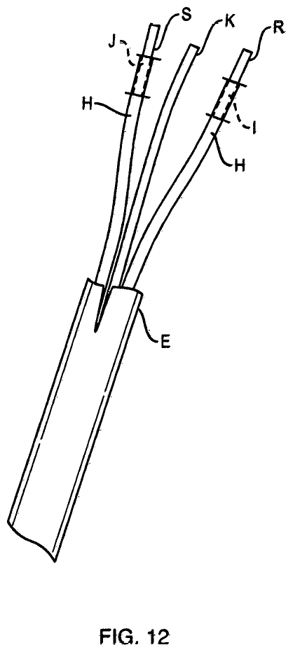

12. FIG. 12 shows the total absence of any nicking following such splitting as shown in FIGS. 9 and 10.

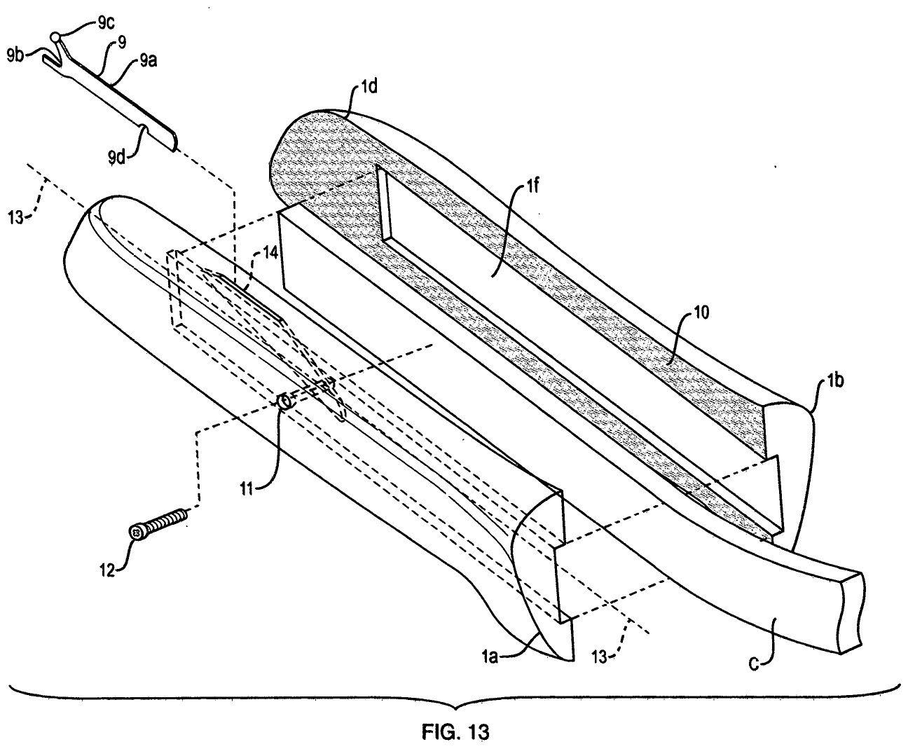

13. FIG. 13 is an exploded perspective view of a variant form of the first embodiment of the invention.

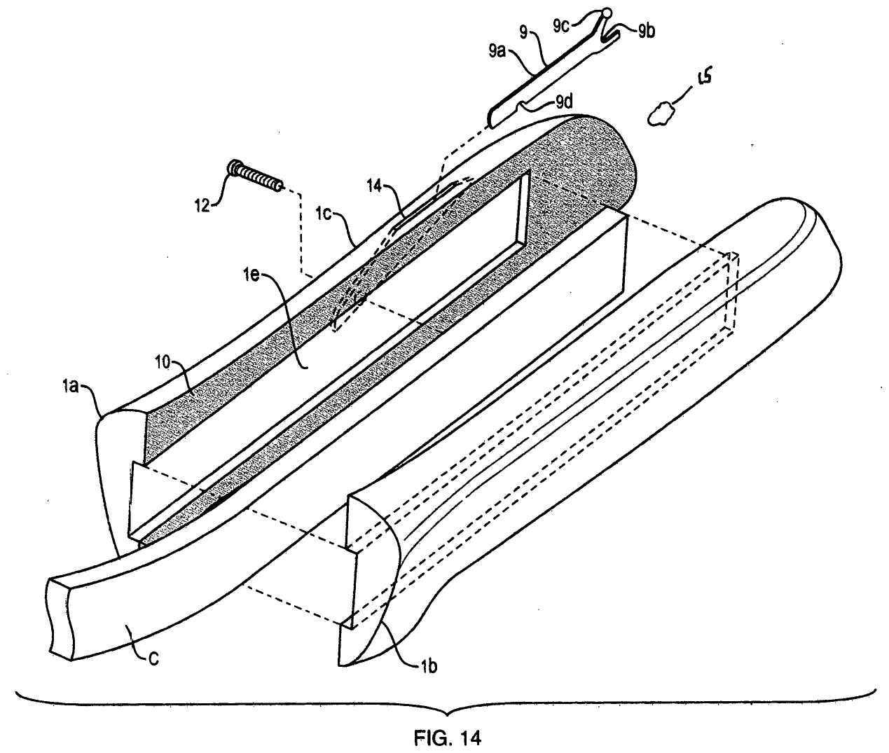

14. FIG. 14 is an exploded perspective view of the variant shown in FIG. 13 but now rotated through an angle of 180°.

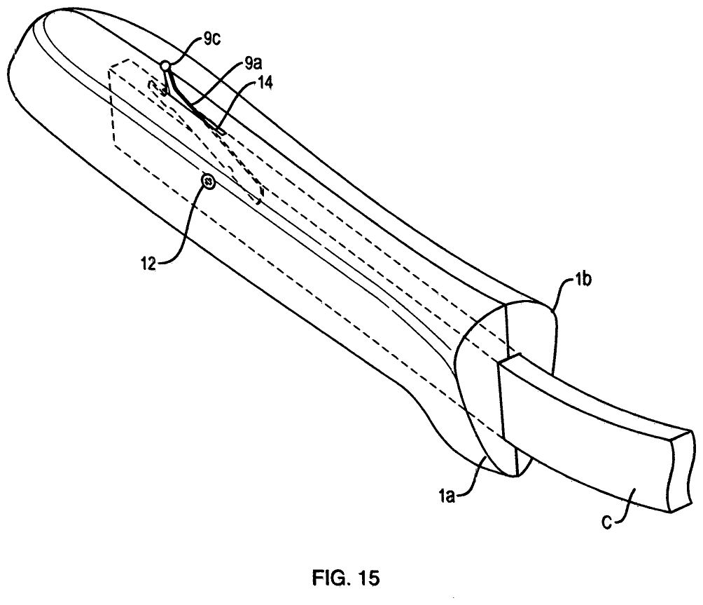

15. FIG. 15 is a perspective view of that intact variant form of the first embodiment of the invention.

### A DESCRIPTION OF THE PREFERRED EMBODIMENTS

FIG. 1 shows in exploded perspective view, the elongated sleeving element 1 of the first embodiment of the invention in apposition to the seam ripper element 9 of the invention. FIG. 2 shows elements 1 and 9 in near apposition to a handle member portion C of an unlocked electrical wire cutting device A. FIG. 3 shows in exploded perspective view, the sleeving element 3 of the second embodiment of the invention in near apposition to the seam ripper element 9 of the invention. FIG. 4 shows elements 3 and 9 of the second embodiment of the invention in near apposition to the shaft member portion D of a screwdriver. FIG. 5 shows the first embodiment of the invention fully assembled to a handle member portion C of a locked electrical wire cutting device A. FIG. 6 shows the second embodiment of the invention fully assembled to the shaft member portion D of a screwdriver. FIG. 7 shows the initial splitting of the outer coating E of overall electrical wiring O with resort to the utilization, for such purposes, of an electrical wire cutting knife G. FIG. 8 shows the nickings L that are often created within the sheathing II circumscribing the ground and power (live) wiring members I and J respectively of a tripartite electrical wiring complex F of overall wiring O, which complex F also consists of a neutral wiring member K, so-called. Such nickings L often occur when such splitting of outer coating E is sought to be accomplished as per FIG. 7 with resort to such a knife G. As earlier mentioned, such nickings L invariably serve to promote electrical arcing; namely, short circuiting or, at least, manifest overheating, each of which is an obvious fire hazard. Such short circuiting and/or overheating; within any bed of insulation Q about the overall wiring O within a building structure's walling P in the near vicinity of, e.g., a switching unit M having had received within it, the unsheathed end portions R and S of wiring members I and J respectively as well as the end portion of member K; with such short circuiting and/or overheating being amenable to being readily caused by such nickings L in any so exposed portions of such sheathing H; all as is seen in FIG. 9; is what constitutes such an obvious fire hazard. Once wiring complex F comprised of wiring members I, J and K and seen in FIG. 8 is so installed into a switching unit M and before any walling P about unit M is closed, wiring complex F and, in particular, any sheathing H about its wiring members I and J; and located just exterior to the confines of any unit M, will need, for safety reasons, to be inspected. Upon such inspection, if a safety inspector happens to see any such nickings L, as seen in FIG. 9, then, it becomes necessary for all of such wiring O to then be removed from within the aegis of such walling P and replaced with wholly new wiring O that would ultimately hopefully not contain any such nickings L. Also, it can readily prove to be the case that any such replacement wiring O also again so split with resort to such a knife G could also be found to have nickings L in that portion of sheathing H just exterior to the confines of a unit M and thus be in need of again being removed and replaced. This process of removal and replacement makes for notable additional expense in terms of construction labor and materials; expense that ought properly to be avoided as often as possible.

FIG. 10 shows an initial splitting of a portion of outer coating E of overall electrical wiring O with resort to use for such purpose, the first embodiment of the invention. The first embodiment features an elongated sleeving element 1, shown in FIG. 5 as having been fitted, e.g., adhesively or perhaps frictionally to a sleeveless handle member portion C of an unlocked electrical wire cutting device A. The adhesive material facilitating such fitting is a glue material 10 illustrated in FIG. 2. Sleeving element 1 features a centrally located closed hole space 2 and is further characterized by the presence of a long vertically inclined central axis of symmetry 5 all as having been shown in FIGS. 1 and 2. Such fitting is accomplished by way of insertion of handle member C, to which glue material 10 has first been applied into closed hole space 2 as is seen, with particularity in FIG. 1. Alternatively, whereas, sleeving element 1 is typically made up of a pliable rubberlike material for purposes of this first embodiment; with sufficient resort having been initially given to precision in the manufacture of sleeving element 1 as respects the sizing of closed hole space 2; sleeving element 1 with hole space 2 can also be made so as to frictionally, snugly and non-removably adhere to a handle member C at once without any need for any resort to any glue material P.

Prior to any such fitting, a roughly right triangularly shaped notch 7, as shown in FIGS. 1 and 2, is carved into the exterior walling of sleeving element 1 at somewhat of a bias relative to the lie of axis 5. Notch 7 serves to removably receive and hold seam ripper element 9 as seen and appreciated with reference to FIG. 9. Seam ripper 9 features a metallic body portion 9a, a sharpened metallic notch portion 9b and a plasticized or rubberized or metallic knob end portion 9c all as seen in FIG. 1. With the body portion 9a of element 9 being so held within notch 7 carved, as just noted, so as to removably receive but snugly hold portion 9a thereof; a person N, with one hand, while holding electrical wire cutting unit A in a locked state, simply then advances unit A and, handle member C thereof, so equipped with the first embodiment, towards an end portion of wiring O, being held by that person N with his/her other hand, and, in turn, accordingly also advances knob end portion 9c ultimately into spacing within wiring O as between outer coating E and sheathing H thereof; in the manner as shown in FIG. 10. Sharpened notch portion 9b then serves to readily facilitate an initial splitting away of coating E from sheathing H as well as away from unsheathed neutral wiring K without any touching whatsoever of sheathing H, and because of the biased lie of notch 7, without any concomitant loosening of element 9 within notch 7 under any pressure on portion 9b as might be brought thereupon by virtue of such advancement. Such splitting away serves to wholly obviate the formation of any nickings L within sheathing H, as may be appreciated with reference to FIG. 12, thereby wholly eliminating any possibility of any electrical arcing or excessive and dangerous heat build-up as between any now non-existent nickings L. Such resort to the use of the first embodiment of the invention thus serves to wholly do away with any need for any concern about any removal and replacement of any such wiring O after any such splitting followed by installation. Once such splitting away has been sufficiently initiated, then further peeling away of coating E can be accomplished by hand, enough to expose enough sheathing H to then be amenable to itself being manually cut back with e.g., a knife G sufficiently enough to create unsheathed and then unprotected end segments R and S of wiring members I and J respectively shown in FIG. 8 to then be wholly inserted and installed into the switching unit M to be wired. The electrical wiring cutting device A is then returned to its unlocked state by squeezing the first handle member C towards its companion handle member and moving unit A's locking component B seen in FIG. 2 to its unlocked state. Once this step is accomplished, then unit A is utilized so as to clip off and trim away any peeled back portions of outer coating E and also to snip and trim away any cut back portions of sheathing H covering the near ending portions of wiring members I and J just proximate to the now unsheathed end segments R and S of wiring members I and J earmarked along with neutral wiring K for secured insertion and installation within the switching unit M.

At this juncture, it should be noted that with repeated use of either embodiment of the invention, the sharp notch portion 9b of the seam ripper element 9 will become increasingly dull and accordingly ineffective as respects any splitting away of coating E. Seam ripper elements 9 are relatively inexpensive and readily available in, e.g., fabric stores typically visited by seamstresses and other cloth fabric sewing personnel. Accordingly; as regards any element 9 so held within a notch 7, once the sharp notch portion 9b thereof would have become dull to a point of relative ineffectiveness with respect to the matter of any wire coating splitting; that element 9 would then be readily, manually removed from notch 7 and replaced with a new element 9.

FIG. 11 shows initial splitting of a portion of outer coating E of electrical wiring O with resort to use, for such a purpose, the second embodiment of the invention. The second embodiment features an elongated sleeving element 3, here shown as in FIG. 6 as having been fitted to a screwdriver shaft member unit D, all as having been previously shown in FIGS. 3 and 4. Such fitting can be accomplished by way of press fitting or alternatively, by way of adhesive fitting with resort to application of an adhesive material to such a shaft member D prior to so conjoining sleeving member 3 via closed hole space 4 to shaft member D. The adhesive material typically facilitating such fitting is, again, a glue material 10 as seen in FIG. 2. Sleeving element 3 features a centrally located closed hole space 4 and is further characterized by the presence of a long vertically inclined central axis of symmetry 6 all as seen in FIG. 3. Such fitting is accomplished by way of insertion of shaft member unit D, to which glue material 10 has first been applied, into closed hole space 4. Alternatively, whereas, sleeving element 3 is typically made up of rigid hard plastic material in the shape of the head of a screwdriver, with sufficient resort having been given to precision in the manufacture of sleeving element 3 as respects the sizing of closed hole space 4, sleeving element 3 with hole space 4 can be made so as to accept a snugly press fitted shaft member unit D as per FIG. 6 without any need for any resort to any glue material 10 for purposes of dependably holding shaft member unit D within hole space 4. Prior to any such fitting, a roughly right triangularly shaped notch 8, as shown in FIGS. 3 and 4, is externally carved into the exterior walling of sleeving element 3 at somewhat of a bias relative to the lie of axis 6. Notch 8 serves to removably receive and hold seam ripper 9 as seen and appreciated with reference to FIG. 11. With element 9 being so held within notch 8, a person N, while holding, with one hand, sleeving element 3 conjoined with shaft member unit D, simply then advances sleeving element 3 towards an end portion of wiring O being held by that person N with his/her other hand, and, in turn, accordingly, also advances knob end portion 9c into spacing within wiring O as between outer coating E and sheathing H thereof. Sharpened notch portion 9b then serves to readily facilitate an initial splitting away of outer coating E without any touching whatsoever of sheathing H, and because of the biased lie of notch 7, without any concomitant loosening of element 9 so held within notch 7 under any pressure on portion 9b as might be brought thereupon by any such advancement. Such splitting away also serves to wholly obviate the formation of any nickings L within sheathing H, thereby wholly eliminating any possibility of any electrical arcing or excessive and dangerous heat build-up owing to the fact of the then nonexistence of any such nickings L and thereby wholly obviating, as well, any need for any concern about any removal and replacement of any such wiring O after any such splitting followed by installation. Once such splitting away has been sufficiently initiated, then further peeling away of coating E can be accomplished by hand, enough to expose enough sheathing H to then be amenable itself to being manually cut back, e.g., with a wire cutting device A, sufficiently enough to again create unsheathed and then unprotected end segments R and S of wiring members I and J to then be wholly inserted and installed into the switching unit M being wired. An electrical wire cutting device A in a locked state, as earlier noted, can then again be utilized so as to clip off and trim away any peeled back portions of coating E and also to snip and trim away any remnant cut back portions of sheathing H covering the near ending portions of wiring members I and J just proximate to the unsheathed end segments R and S of wiring members I and J earmarked along with neutral wiring member K for secured insertion and installation within the switching unit M.

FIG. 12 shows wiring O, the outer coating E of which has been initially split away with resort to utilization, for such purposes, of either the first or second embodiment of the invention In both instances, sheathing H circumscribing each of wiring members I and J thereof, is found not to have been burdened with any nickings L.

A variant form in respect of the initially disclosed first embodiment of the invention is one as is shown in FIG. 13 and FIG. 15 wherein elongated sleeving element 1 consists of two oppositely crafted, elongated rigid portions first rigid portion, 1a and second rigid portion, 1b being when adherent fast together, the equivalent of element 1. Each such portion has internal walling 1c and 1d respectively to which adhesive affixation means such as glue material 10 is applied so as to thereby hold portion 1a and portion 1b fast together and about handle member portion C of wire cutting device A. This glue material 10 is shown in FIGS. 13 and 14 as stippling about such internal walling 1c and 1d. Other affixation means include resort to weld material 15 applied by way of welding the same to the inner walling 1c of first rigid portion 1a or the inner walling 1d of second rigid portion 1b to hold rigid portion 1a when made up of a metallic material and rigid portion 1b when made up of a metallic material fast to one another about handle member portion C within first long notch 1e and second long notch 1f. Such weld material 15 is shown in FIG. 14. This variant also features a long second central axis of symmetry 13 of portion 1a. Each of portions 1a and 1b also features respectively one of equivalent first and second long notches 1e and 1f with each of such notches serving in an acceptance of handle member portion C by each of rigid portions 1a and 1b and culminating ultimately in such acceptance of portion C by the equivalent of a so formed, in effect closed hole space 2 of a sleeving element 1 so formed via such affixation of portions 1a and 1b about handle C. Seam ripper element 9 in respect of a variation thereof has cut into it a second notch 9d. A new receiving notch 14 as shown in FIG. 14 is carved into the interior walling of portion 1a at somewhat of a bias relative to the lie of the long second central axis of symmetry 13 of portion 1a. Notch 14 serves to removably hold in place seam ripper element 9 about the body portion 9a thereof. A threaded hole 11 found in portion 1a serves to threadably accept a screw unit 12 that is also acceptable through notch 9d of seam ripper element 9 held within notch 14 and such that the end edge of screw unit 12 is also screwed fast to the outer walling of handle member portion C. This feature is seen schematically in FIG. 14 by way of a showing of a dotted line extending from hole 11 to the outer walling of handle member portion C. At such times as seam ripper element 9 becomes dull within metallic notch portion 9b by virtue of multiple uses of the device, the dull seam ripper element 9 is simply removed from notch 14 by way of unscrewing screw unit 12, removing the dull seam ripper element 9, replacing it with a new seam ripper element 9 and then screwing screw unit 12 again fast to the outer walling of handle member portion C. The advantage that this variant has, relative to the initially disclosed first embodiment, is that this variant given its inherent rigidity features better insulating capabilities than does the initially disclosed first embodiment. Moreover, by virtue of such inherent rigidity, this variant also serves to prevent slippage and/or disconnection during normal operation more so than does the initially disclosed first embodiment. Moreover, this variant is inherently more comfortable to hold than is the initially disclosed first embodiment. Finally, such inherent rigidity of this variant serves to extend the useful life of the invention as well.

In conclusion, respectfully submitted, the instant invention is not only new, useful and unique, but, rather instead, is indeed one, that is veritably revolutionary in the art involving initial abrogation of the outer coating portion of electrical wiring.

1. (canceled)

2. (canceled)

3. (canceled)

4. (canceled)

5. (canceled)

6. (canceled)

7. (canceled)

8. An electrical wiring outer coating splitting device, comprising:
a. a first rigid portion of an elongated sleeving unit;
b. a second rigid portion of an elongated sleeving unit;
c. first internal walling of said first rigid portion;
d. second internal walling of said second rigid portion;
e. a first long notch cut into said first rigid portion;
f. a second long notch cut into said second rigid portion;
g. affixation means applied to said first internal walling and said second internal walling so as to conjoin said first rigid portion and said second rigid portion fast about a handle member portion of a wiring cutting device within said first long notch and said second long notch;
h. a long second central axis of symmetry in respect of said first rigid portion so affixed about said handle member portion;
i. a new receiving notch cut into interior walling of said first rigid portion;
j. said new notch being so cut as to be at a bias relative to a lie of said second central axis of symmetry;
k. a seam ripper element with a body portion thereof being removably receivable from said new notch and having said body portion thereof, a sharp notch portion thereof adjacent said body portion, a second notch cut into said body portion and a knob end portion thereof adjacent said sharp notch portion;
l. a threaded hole cut into said first rigid portion at a locus therein of said new receiving notch;
m. said threaded hole being so cut perpendicularly relative to a lie of said second central axis of symmetry, and;
n. a screw unit threadably receivable by said threaded hole and said second notch.

9. The electrical wiring outer coating splitting device of claim 8 whereby, said first portion and said second portion are made of rigid, hard plastic material.

10. The electrical wiring outer coating splitting device of claim 8 whereby, said first portion and said second portion are made of rigid, hard metallic material.

11. The electrical wiring outer coating splitting device of claim 8 whereby, said affixation means are a glue substance.

12. The electrical wiring outer coating splitting device of claim 8 whereby, said affixation means are a glue like adhesive substance.

13. An electrical wiring outer coating splitting device, comprising:
a. a first metallic rigid portion of an elongated sleeving unit;
b. a second metallic rigid portion of an elongated sleeving unit;
c. first internal walling of said first rigid portion;
d. second internal walling of said second rigid portion;
e. a first long notch cut into said first rigid portion;
f. a second long notch cut into said second rigid portion;
g. affixation means applied to said first internal walling and said second internal walling so as to conjoin said first rigid portion and said second rigid portion fast about a handle member portion of a wiring cutting device within said first long notch and said second long notch;
h. a long second central axis of symmetry in respect of said first rigid portion so affixed about said handle member portion;
i. a new receiving notch cut into interior walling of said first rigid portion;
j. said new notch being so cut as to be at a bias relative to a lie of said second central axis of symmetry;
k. a seam ripper element with a body portion thereof being removably receivable from said new notch and having said body portion thereof, a sharp notch portion thereof adjacent said body portion, a second notch cut into said body portion and a knob end portion thereof adjacent said sharp notch portion;
l. a threaded hole cut into said first rigid portion at a locus therein of said new receiving notch;
m. said threaded hole being so cut perpendicularly relative to a lie of said second central axis of symmetry, and;
n. a screw unit threadably receivable by said threaded hole and said second notch.

14. The electrical wiring outer coating splitting device of claim 13 whereby, said affixation means are a weld material.
